(19) United States
(12) Patent Application Publication
(10) Pub. No.: US 2024/0151445 A1
(43) Pub. Date: May 9, 2024

(54) HEAT EXCHANGER INTEGRATION WITH MEMBRANE SYSTEM FOR EVAPORATOR PRE-CONCENTRATION

(71) Applicant: Via Separations, Inc., Watertown, MA (US)

(72) Inventors: Kyle VANZANDT, Watertown, MA (US); Marcus LUNDGREN, Cambridge, MA (US); Brent D. KELLER, Somerville, MA (US)

(73) Assignee: Via Separations, Inc., Watertown, MA (US)

(21) Appl. No.: 18/413,994

(22) Filed: Jan. 16, 2024

Related U.S. Application Data
(63) Continuation of application No. 18/141,316, filed on Apr. 28, 2023, now Pat. No. 11,913,692.
Application No. 18/141,316 is a continuation of application No. PCT/US2022/080120, filed on Nov. 18, 2022.
(60) Provisional application No. 63/283,767, filed on Nov. 29, 2021.

(51) Int. Cl. F25B 43/00; B01D 71/02

(52) U.S. Cl. CPC F25B 43/00; B01D 71/024; B01D 2311/04; B01D 2311/106

(57) ABSTRACT

A system for processing a feed includes a membrane system configured to receive the feed and produce a concentrate and a permeate, wherein the membrane system includes an active cooling system, a passive cooling system, or a combination thereof. Further, the system includes a heat exchanger in fluid communication with the membrane system and disposed upstream of the membrane system, such that the feed enters the heat exchanger prior to entering the membrane system, wherein the heat exchanger is configured to cool the feed and heat the concentrate by transferring heat from the feed to the concentrate.

### CROSS REFERENCE TO RELATED APPLICATIONS

This application is a continuation of U.S. patent application Ser. No. 18/141,316, entitled “Heat Exchanger Integration with Membrane System for Evaporator Pre-concentration,” filed Apr. 28, 2023, which is a continuation of International Patent Application No. PCT/US2022/080120, entitled “Heat Exchanger Integration with Membrane System for Evaporator Pre-concentration,” filed Nov. 18, 2022, which claims priority to and the benefit of U.S. Provisional Patent Application No. 63/283,767, entitled “Heat Exchanger Integration with Membrane System for Evaporator Pre-concentration,” filed Nov. 29, 2021, the disclosure of each of which is hereby incorporated by reference in its entirety.

### TECHNICAL FIELD

The present disclosure generally relates to systems, apparatuses, and methods for combining heat exchangers and membranes.

### BACKGROUND

Various membranes (e.g., polymer membranes or graphene oxide membranes) have been used for water softening, desalination, and for the concentration, removal, and purification of different salts, small molecules, and macromolecules. However, at high temperatures, the membranes can become damaged, thereby reducing their operating life and separation performance.

In addition, membranes are used to pre-concentrate feed streams (referred to as a concentrate) to evaporators. Evaporators (and other high-temperature processes such as reactors and distillation columns) typically operate best with high feed temperatures, whereas membrane separation systems typically perform better at lower temperatures. As such, energy needs to be expended to heat the concentrate before it is fed to evaporators.

Accordingly, there is a need in the art of filtering systems for cooling a feed, as well as for heating a concentrate produced by a membrane in an environmentally friendly manner.

### SUMMARY

Consistent with a disclosed embodiment, a system for processing a feed is provided. The system includes a membrane system configured to receive the feed and produce a concentrate and a permeate, wherein the membrane system includes an active cooling system, a passive cooling system, or a combination thereof. Further, the system includes a heat exchanger in fluid communication with the membrane system and disposed upstream of the membrane system, such that the feed enters the heat exchanger prior to entering the membrane system, wherein the heat exchanger is configured to cool the feed and heat the concentrate by transferring heat from the feed to the concentrate.

In some implementations, the feed comprises a liquid.

In some implementations, the heat exchanger operates at about atmospheric pressure.

In some implementations, the heat exchanger is configured to transfer about 0.24 to about 0.39 BTU/gallon from the feed to the concentrate.

In some implementations, the heat exchanger is configured to have a heat transfer coefficient in a range of about 100 to about 500 BTU per hour-square feet-Fahrenheit.

In some implementations, the heat exchanger is configured to have about 900 to about 1,000 square feet of effective heat transfer area.

In some implementations, the passive cooling system includes uninsulated piping, a membrane housing, or a combination thereof.

In some implementations, the active cooling system includes at least one of a water sprayer, a heat sink with cooling fins, or a membrane system heat exchanger.

In some implementations, the membrane system includes both the active cooling system and the passive cooling system. Additionally, in some implementations the system further includes a controller configured to determine performance of the passive cooling system and adjust an operation of the active cooling system based on the determined performance of the passive cooling system, such that the cooling of the membrane system is at a target cooling level.

Further, in some implementations, the controller is further configured to control an operation of the heat exchanger to control a temperature of the feed based on the determined performance of the passive cooling.

In some implementations, the system further includes a controller configured to determine a temperature of the concentrate before the concentrate enters the heat exchanger or after the concentrate leaves the heat exchanger and adjust a heat transfer rate between the feed and the concentrate based on the determined temperature of the concentrate.

Further, in some implementations, adjusting the heat transfer rate includes reducing or increasing an effective heat transfer area of the heat exchanger.

Further, in some implementations, adjusting the heat transfer rate includes separating a flow of the feed into a first flow and a second flow, wherein the first flow is configured to pass through the heat exchanger, the second flow is configured to bypass the heat exchanger, and the controller is configured to determine a magnitude of the first flow and/or second flow. Further, adjusting the heat transfer rate includes recombining the first and the second flow after the first flow passes through the heat exchanger.

In some implementations, the system further includes a controller configured to determine a temperature of a membrane in the membrane system and adjust a heat transfer rate between the feed and the concentrate based on the determined temperature of the membrane.

Further, in some implementations, the controller is configured to increase a temperature of the feed if the membrane temperature is below a target temperature value and decrease the temperature of the feed if the membrane temperature is above the target temperature value.

In some implementations, a temperature difference between the concentrate prior to entering the heat exchanger and the feed prior to entering the heat exchanger is between about 10-40 degrees Celsius.

In some implementations, the system includes a controller configured to determine a temperature (T_{c}) of the concentrate, determine a temperature (T_{f}) of the feed, and adjust a heat transfer rate between the feed and the concentrate based on the determined T_{c} and T_{f} to minimize a system objective function F.

Further, in some implementations, the system objective function F is F=w₁(T_{c}−T_{c ref})²+w₂(T_{f}−T_{f ref})², wherein T_{c ref} is a concentrate reference temperature, and T_{f ref} is a feed reference temperature, and w₁ and w₂ are weights ranging between zero and one.

In some implementations, the system includes a controller configured to determine a change in a flow rate of the feed and adjust a heat transfer rate in the heat exchanger based on the determined change in the flow rate of the feed.

In some implementations, the membrane system includes both the active cooling and the passive cooling. In some implementations, the system further includes a controller configured to determine a change in a flow rate of the feed, adjust a heat transfer rate in the heat exchanger based on the determined change in the flow rate of the feed, and adjust an operation of the active cooling system based on the determined change in the flow rate of the feed.

In some implementations, the membrane system comprises a graphene oxide membrane.

In some implementations, the feed enters the heat exchanger at a flow rate of about 165 to about 220 klb/hr.

In some implementations, the concentrate enters the heat exchanger at a flow rate of about 110 to about 165 klb/hr.

Consistent with another disclosed embodiment, a system for processing a feed is provided. The system includes a membrane system configured to receive the feed and produce a concentrate and a permeate, the membrane system including an active cooling system, a passive cooling system, or a combination thereof. Further, the system includes a first heat exchanger in fluid communication with the membrane system and disposed upstream of the membrane system and a second heat exchanger in fluid communication with both the first heat exchanger and the membrane system. The second heat exchanger is disposed between the first heat exchanger and the membrane system, such that the feed enters the first heat exchanger, the second heat exchanger, and the membrane system sequentially. Further, the first heat exchanger is configured to cool the feed and heat the concentrate by transferring heat from the feed to the concentrate, and the second heat exchanger is configured to cool the feed and heat the permeate by transferring heat from the feed to the permeate.

In some implementations, a temperature difference between the concentrate prior to entering the first heat exchanger and the feed prior to entering the first heat exchanger is between about 10-40 degrees.

Further, in some implementations, a difference in temperature between the concentrate prior to entering the first heat exchanger and the permeate prior to entering the second heat exchanger is between about 0-15 degrees Celsius.

In some implementations, the system also includes a controller configured to determine a temperature of a membrane in the membrane system, adjust a heat transfer rate in the first heat exchanger based on the determined temperature of the membrane, and adjust a heat transfer rate in the second heat exchanger based on the determined temperature of the membrane.

In some implementations, the system includes a controller configured to determine a temperature of the concentrate before the concentrate enters the heat exchanger or after the concentrate leaves the heat exchanger, determine a temperature of a membrane in the membrane system, adjust a heat transfer rate in the first heat exchanger based on the determined temperature of the concentrate, and adjust a heat transfer rate in the second heat exchanger based on the determined temperature of the membrane.

In some implementations, the system includes a controller configured to determine a change in a flow rate of the feed and adjust a heat transfer rate in the first heat exchanger or the second heat exchanger based on the determined change in the flow rate of the feed.

Further, in some implementations, the membrane system comprises a graphene oxide membrane.

In some implementations, the system includes a controller configured to determine a temperature (T_{c}) of the concentrate, determine a temperature (T_{f}) of the feed, determine a temperature (Tₚ) of the permeate, and adjust a heat flow between the feed and the concentrate and between the feed and the permeate based on the determined T_{c}, T_{f}, and Tₚ to minimize a system objective function F.

Further, in some implementations, the system objective function F is F=w₁(T_{c}−T_{c ref})²+w₂(T_{f}−T_{f ref})², wherein T_{c ref} is a concentrate reference temperature, and T_{f ref} is a feed reference temperature, and w₁ and w₂ are weights ranging between zero and one.

Further, in some implementations, the system objective function F is F=(T_{c}−T_{c ref})²+w₂(T_{f}−T_{f ref})²+w₃(Tₚ T_{p ref}), wherein T_{c ref} is a concentrate reference temperature, T_{f ref} is a feed reference temperature, and T_{p ref} is a permeate reference temperature, and w₁, w₂, and w₃ are weights ranging between zero and one.

The foregoing general description and the following detailed description are exemplary and explanatory only and are not restrictive of the claims.

### BRIEF DESCRIPTION OF THE DRAWINGS

FIG. 1 is an example system for processing a feed, according to an embodiment.

FIG. 2 is another example system for processing a feed, according to an embodiment.

FIG. 3 is an example system, including a controller for processing a feed, according to an embodiment.

FIG. 4A is an example process of adjusting the performance of an active cooling system, according to an embodiment.

FIG. 4B are example sub-steps of the process of FIG. 4A, according to an embodiment.

FIG. 5 is an example process of adjusting a heat transfer between a feed and a concentrate, according to an embodiment.

FIG. 6 is an example process of adjusting a heat transfer rate in a heat exchanger and adjusting an operation of an active cooling system, according to an embodiment.

FIG. 7 is another example process of adjusting a heat transfer between a feed and a concentrate, according to an embodiment.

FIG. 8 is an example process of adjusting a heat transfer rate in a first heat exchanger and a second heat exchanger, according to an embodiment.

FIG. 9 is another example process of adjusting a heat transfer rate in a first heat exchanger and a second heat exchanger, according to an embodiment.

FIG. 10 is an example process of adjusting a heat transfer between a feed and a concentrate and adjusting a heat transfer between a feed and a permeate, according to an embodiment.

FIG. 11 is an example process of determining heat exchange parameters, according to an embodiment.

FIG. 12 are tables depicting possible parameters for processing a feed using the systems of the present disclosure, according to an embodiment.

### DETAILED DESCRIPTION

Aspects of the present disclosure are related to systems and methods for concentrating a feed stream (herein simply referred to as a feed) prior to the feed entering an evaporator, thus, making the evaporation process more energy efficient. Evaporators (and other high temperature processes such as reactors and distillation columns) typically operate better with high feed temperatures, whereas membrane separation systems typically perform better at lower temperatures. Besides membrane system, there are other systems, which may also benefit from the feed being at a lower temperature. Such systems may include system for precipitation, phase separations, skimming, chromatography, extraction, absorption, and the like.

An example process that involves a membrane system is the process of obtaining a concentrated solution (e.g., a concentrated black liquor). Such a process may occur intermediate or before high temperature evaporation. The separation of water from black liquor using membrane systems may be performed at a lower temperature (e.g., various membrane systems may benefit from operating at temperatures that are lower than temperatures used for evaporation), however, frequently, such separation is performed at a high temperature because of the requirements of other processes (e.g., evaporation). Using approaches described in this disclosure, a concentrated feed can be produced by the membrane systems to further reduce water content in the black liquor, with the concentrated feed obtained at temperatures lower than what is currently used in the technology. In some cases, after the process using the membrane systems, tall oil or soap can be removed from the concentrated black liquor before it is reheated.

To address the fact that different systems (e.g., evaporators, distillers, membrane systems, and the like) require different operational temperatures, the present disclosure describes various embodiments of a system that improves heat management for: (a) reducing energy waste; and (b) increasing the operating life and separation performance of membrane systems.

It should be also noted, that for a membrane system, the disclosed embodiments describe transferring heat from the feed to a concentrate and/or to a permeate produced by the membrane system. Since the concentrate and the permeate are always a fraction of the feed flow, the temperature rise of the concentrate or the permeate is typically higher than the temperature change of the feed being cooled during the heat transfer from feed to the concentrate (and/or the permeate). Thus, the concentrate (and/or permeate) can be heated close to a target temperature value despite large amounts of passive or active cooling of the membrane system.

In some cases, a membrane system cannot operate at the temperature of the feed or the required temperature of the concentrate (or permeate). By integrating a heat exchanger, passive cooling, and/or active cooling, the membrane system can operate at twenty, thirty, or more degree Celsius below the required temperatures of the other operations.

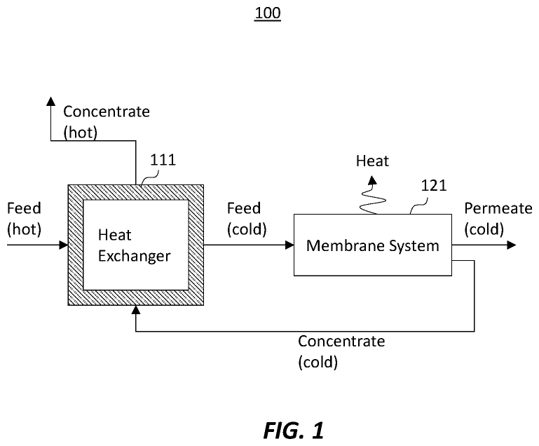

Aspects of the present disclosure are related to a system 100 for processing a feed and producing a concentrate, each of which at a desirable temperature or temperature range, as shown in FIG. 1. The system 100 includes a heat exchanger 111 and a membrane system 121. In some implementations, other than coupling elements (e.g., pipes or channels) that connect the heat exchanger 111 and the membrane system 121, there are no additional devices between the heat exchanger 111 and the membrane system 121.

The heat exchanger 111 is in fluid communication with the membrane system 121 and disposed upstream of the membrane system 121, such that the feed enters the heat exchanger 111 to be cooled prior to entering the membrane system 121. The heat exchanger 111 may be any suitable heat exchanger configured to cool the feed and heat the concentrate by transferring heat from the feed to the concentrate. In an example implementation, as shown in FIG. 1, the cold concentrate from the membrane system 121 is heated in the heat exchanger 111 while the feed is cooled by dissipating the heat towards the concentrate. In an example implementation, the heat exchanger 111 is a convection/conduction heat exchanger (e.g., the heat exchanger 111 utilizes the transfer of thermal energy from a surface by way of the motion of a cold concentrate relative to the surface of an enclosure containing a hot feed). Herein, the term “hot” indicates that the feed is at a higher temperature than the cold concentrate. During the heat exchange, the concentrate may be heated by about a few tens of degrees. In an example embodiment, the concentrate may be heated by at least about 10 degrees Celsius (10° C.) and by no more than about 40° C. Further, the feed may be cooled by about a few degrees to a few tens of degrees. For example, the feed may be cooled by at least about 5° C. and by no more than about 30° C.

In some implementations, in addition to using the cold concentrate, or alternatively to using a cold concentrate to cool the feed, a different liquid may be utilized. For example, a chilled fluid (e.g., chilled water or antifreeze) may be utilized additionally (or alternatively) to cool the feed. In some cases, a first piping system of the heat exchanger 111 may be used to cool the feed using the cold concentrate, and a second piping system of the heat exchanger 111 may be used to cool the feed using a chilled fluid. Additionally, besides using the concentrate or the chilled fluid as cooling agents, the heat exchanger 111 may also use other approaches for cooling the feed (e.g., thermoelectric cooling, refrigeration system, or the like).

In some implementations, the heat exchanger 111 may include passive cooling elements in addition to active cooling elements that utilize cold concentrate and chilled fluids. For example, the heat exchanger 111 may include suitable heatsinks, and the like. In some implementations, the heat exchanger 111 includes heat pipes, fans, or any other devices for promoting the removal of heat from the feed. In various implementations, the heat exchanger 111 may be exposed to an ambient environment (e.g., to outside air) and operate and at about atmospheric pressure.

In an example implementation, the heat exchanger 111 may transfer any suitable amount of heat from the feed to the concentrate. For example, the heat exchanger 111 may be configured to transfer at least about 0.14 BTU/gallon, about least about 0.19 BTU/gallon, at least about 0.24 BTU/gallon, at least about 0.29 BTU/gallon, at least about 0.34 BTU/gallon, about least about 0.39 BTU/gallon, at least about 0.44 BTU/gallon, or at least about 0.49 BTU/gallon from the feed to the concentrate. The heat exchanger 111 may be configured to transfer no more than about 0.72 BTU/gallon, no more than about 0.67 BTU/gallon, no more than about 0.62 BTU/gallon, no more than about 0.57 BTU/gallon, no more than about 0.52 BTU/gallon, no more than about 0.49 BTU/gallon, no more than about 0.44 BTU/gallon, or no more than about 0.39 BTU/gallon from the feed to the concentrate.

Combinations of the above-referenced ranges for the rate of heat transfer are also contemplated. For example, in certain implementations, the heat exchanger 111 may be configured to transfer about 0.14 to about 0.72 BTU/gallon or about 0.24 to about 0.39 BTU/gallon from the feed to the concentrate, inclusive of all values and ranges therebetween.

In some implementations, the heat exchanger 111 is configured to have a heat transfer coefficient of at least about 60 BTU per hour-square feet-Fahrenheit, at least about 70 BTU per hour-square feet-Fahrenheit, at least about 80 BTU per hour-square feet-Fahrenheit, at least about 90 BTU per hour-square feet-Fahrenheit, at least about 100 BTU per hour-square feet-Fahrenheit, at least about 110 BTU per hour-square feet-Fahrenheit, or at least about 120 BTU per hour-square feet-Fahrenheit. In some implementations, the heat exchanger 111 is configured to have a heat transfer coefficient of no more than about 800 BTU per hour-square feet-Fahrenheit, not more than about 750 BTU per hour-square feet-Fahrenheit, no more than about 700 BTU per hour-square feet-Fahrenheit, no more than about 700 BTU per hour-square feet-Fahrenheit, no more than about 650 BTU per hour-square feet-Fahrenheit, no more than about 600 BTU per hour-square feet-Fahrenheit, no more than about 550 BTU per hour-square feet-Fahrenheit, or no more than about 500 BTU per hour-square feet-Fahrenheit.

Combinations of the above-referenced ranges for the heat transfer coefficient of the heat exchanger 111 are also contemplated. For example, in certain implementations, the heat transfer coefficient of the heat exchanger 111 is in a range of about 60 to about 800 BTU per hour-square feet-Fahrenheit or about 100 to about 500 BTU per hour-square feet-Fahrenheit, inclusive of all values and ranges therebetween.

The heat exchanger 111 includes a heat transfer area over which the concentrate and the feed can interact. For example, the heat transfer area may be a heat-conducting surface of an enclosure such that the feed is located on one side of the surface and the concentrate is located on another side of the surface. In an example implementation, the enclosure may include a set of pipes, a set of channels (e.g., ducts), and the like. The heat transfer area for the heat exchanger 111 may be a few hundred of feet squared or as much as a thousand feet squared. In some cases, heat transfer area may be in a range of 500-5000 feet squared.

In some implementations, the heat exchanger 111 is configured to have a heat transfer area of at least about 500 feet squared, at least about 700 feet squared, at least about 900 feet squared, at least about 1200 feet squared, or at least about 1400 feet squared. In some implementations, the heat exchanger 111 is configured to have the heat transfer area of no more than about 1000 feet squared, no more than about 2000 feet squared, no more than about 3000 feet squared, no more than about 4000 feet squared, or no more than about 5000 feet squared.

The membrane system 121 is configured to receive the feed and produce a concentrate and a permeate. The membrane system 121 may be any suitable system for filtering the feed. For example, the membrane system 121 may include a membrane (e.g., a graphene oxide membrane formed from multiple graphene oxide sheets, a polymeric membrane, or a composite membrane) that is supported by a support substrate. In an example embodiment, a combination of different types of membranes may be used. For example, a graphene oxide membrane may be used first, and a polyamide membrane can follow the graphene oxide membrane and further filter the permeate after the permeate is sufficiently cooled. Because sufficiently high temperatures (e.g., above 75° C.) can cause damage to membranes (e.g., the sufficiently high temperatures can cause pore dilation, loss of rejection, hydrolysis, glue line failure, increased intrusion, loss of flux, and the like), the membrane system 121 is configured to have a cooling system. In an example embodiment, graphene oxide membrane may be configured to operate in a temperature range of 60°−75° C., including all the temperature values in between. In some cases, temperatures of 70°−80° C. may be used to integrate with pulp production. In some implementations of the membrane system 121, membrane temperatures in a range of 35°−40° C. may be used, including all the temperature values in between. For example, the membrane system 121 operating at lower temperatures (e.g., temperatures in the range of 35°−40° C.) may be well suited for reverse osmosis (RO) systems. In some implementations of the membrane system 121, temperatures of 40°−60° C. degrees may be used, including all the temperature values in between. Example graphene oxide membranes are disclosed in U.S. Pat. Nos. 11,123,694 and 11,097,227, each of which is incorporated herein by reference and attached hereto as Exhibits A and B, respectively.

In an example implementation, the membrane system 121 includes a passive cooling system. For example, the passive cooling system may include uninsulated piping, a membrane housing, or a combination thereof. In some cases, the passive cooling system includes suitable heatsinks configured to conduct heat away from the membrane. The heatsinks may be formed from any suitable metal (e.g., copper, aluminum, steel, and the like). In some cases, the heatsinks may include fins configured to dissipate heat into surrounding ambient air.

Additionally, or alternatively, the membrane system 121 includes an active cooling system. The active cooling system may include fans for improving heat dissipation from the fins of one or more heatsinks. Additionally, or alternatively, the active cooling system includes a water sprayer for spraying water over parts of the membrane system 121 (e.g., for spraying water over a heatsink of the membrane system 121). In some implementations, the active cooling system may include a heat exchanger configure to transfer heat to a cooled water stream. Further, the active cooling system may include a suitable membrane system heat exchanger.

As shown in FIG. 1, the heat is extracted from the membrane system 121, and the membrane system 121 produces a concentrate and permeate at a temperature lower than the temperature of the incoming feed. Such a concentrate and permeate are referred to as a “cold” concentrate or permeate. In an example embodiment, the temperature of the concentrate prior to entering the heat exchanger 111 may be about 10-40 degrees lower than the temperature of the feed prior to entering the heat exchanger 111 (e.g., the temperature of the concentrate may be in a range of 40° to 70° C., including all the temperature values in between, while the temperature of the feed prior to entering the heat exchanger 111 may be between 85° and 95° C., including all the temperature values and ranges in between). The temperature of the permeate exiting the membrane system 121 may be about the same as the temperature of the concentrate (e.g., in a range of 40° to 70° C.), including all the temperature values in between. In the embodiment shown in FIG. 1, the feed, the concentrate, and the permeate are fluids. In an example implementation, the feed, the concentrate, and the permeate are liquids.

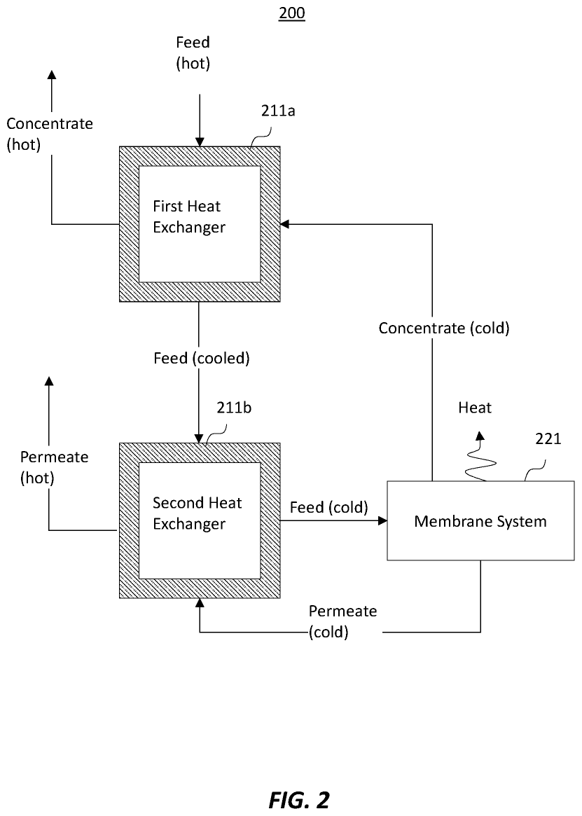

FIG. 2 shows another embodiment of a system 200, which is similar to the system 100. The system 200 includes a first heat exchanger 211a, a second heat exchanger 211b, and a membrane system 221. The second heat exchanger 211b is in fluid communication with both the first heat exchanger 211a and the membrane system 221 and disposed between the first heat exchanger 211a and the membrane system 221. As shown in FIG. 2, the feed first enters the first heat exchanger 211a, then proceeds to the second heat exchanger 211b, and after exiting the second heat exchanger 211b, further proceeds to the membrane system 221.

Similar to the system 100, the cold concentrate from the membrane system 221 is configured to exchange heat with the feed using the first heat exchanger 211a. Further, the cold permeate is configured to exit the membrane system 221 and be used as a cooling agent in the second heat exchanger 211b. In an example embodiment, in order for the feed to exchange heat with the permeate in the second heat exchanger 211b, the feed is at a higher temperature than the permeate.

The second heat exchanger 211b may be configured to be similar to the first heat exchanger 211a, but with a difference that the permeate is used as a cooling agent instead of the concentrate. Alternatively, the second heat exchanger 211b may have a different geometry than the first heat exchanger 211a, may have a different heat transfer area, or may have different passive or active cooling devices. In an example implementation, the second heat exchanger 211b may include heatsinks, fans, heat pipes, and the like. Additionally, besides using permeate as a cooling agent, the second heat exchanger 211b may also use other approaches for cooling feed (e.g., using chilled fluids, such as water, using thermoelectric cooling, using refrigeration system, and the like).

In some implementations of the system 100 or 200, the temperature difference between the concentrate, prior to entering the heat exchanger 111 or the first heat exchanger 211a, and the feed prior to entering the heat exchanger 111 or the first heat exchanger 211a is between about 10-40 degrees Celsius. Additionally, or alternatively, the temperature difference between the concentrate prior to entering the first heat exchanger 211a, and the permeate prior to entering the second heat exchanger 211b, is relatively small (e.g., less than a few degrees Celsius). However, in some implementations, the temperature difference between the concentrate and the permeate may be up to about fifteen degrees Celsius. After the first heat exchanger 111 (or the first heat exchanger 211a), the temperature of the feed and the temperature of the concentrate (after being heated in the first heat exchanger 111) is about 1° to 20° C. For example, the feed temperature (after passing through the first heat exchanger 111) may be between 60°−75° C., and the concentrate temperature (after passing through the first heat exchanger 111) may be between 80°−85° C.

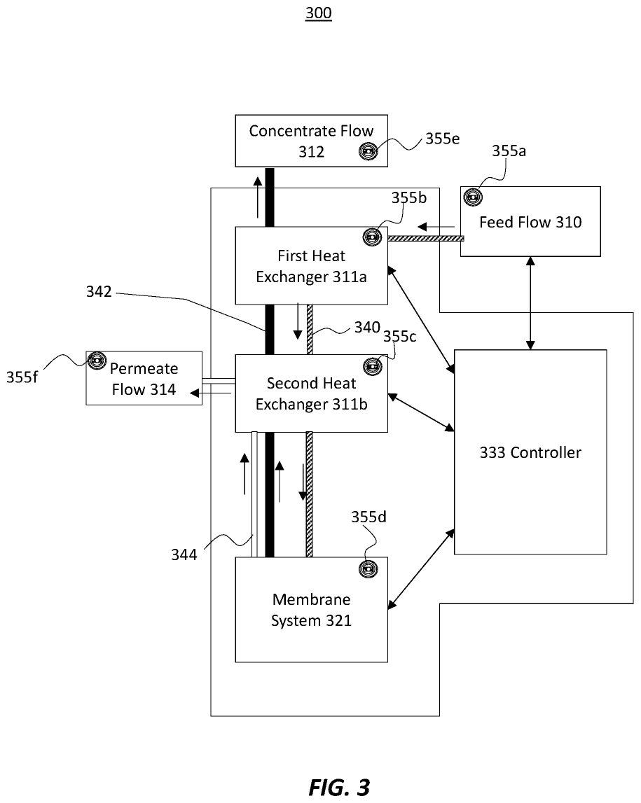

In various implementations, the system 100 and/or the system 200 may include a controller configured to control temperatures of the feed for the membrane system 121 or 221. An example controller 333 for a system 300 is shown in FIG. 3. The system 300 may be the same as the system 200 except that the system 300 further includes the controller 333 and any one or a combination of sensor 355a-355f. Example sensors 355a-355f may include flowrate sensors, pressure sensors, temperature sensors, velocity sensors, and the like.

As shown in FIG. 3, the system 300 includes a first heat exchanger 311a a second heat exchanger 311b, a membrane system 321, a controller 333, and one or a combination of sensors 355a-355f. The controller 333 can be configured to control various aspects of operations of system 300. In an example implementation, the controller 333 can be configured to control a feed flow 310. In an example implementation, the feed flow 310 is controlled by controlling a suitable device for providing the feed flow 310. For example, the controller 333 can be configured to control a pump for providing the feed flow 310 to the membrane system 321. The controller 333 may be configured to control a flowrate or pressure of the feed at the inflow to the first heat exchanger 311a. In an example embodiment, a flowrate sensor 355a associated with the feed flow 310 is configured to provide data to the controller 333, and the controller 333 is configured to adjust the flowrate based on the data from the sensor 355a. As shown in FIG. 3, the feed is flown through a line 340, the concentrate is flown through line 342, and the permeate is flown through a line 344.

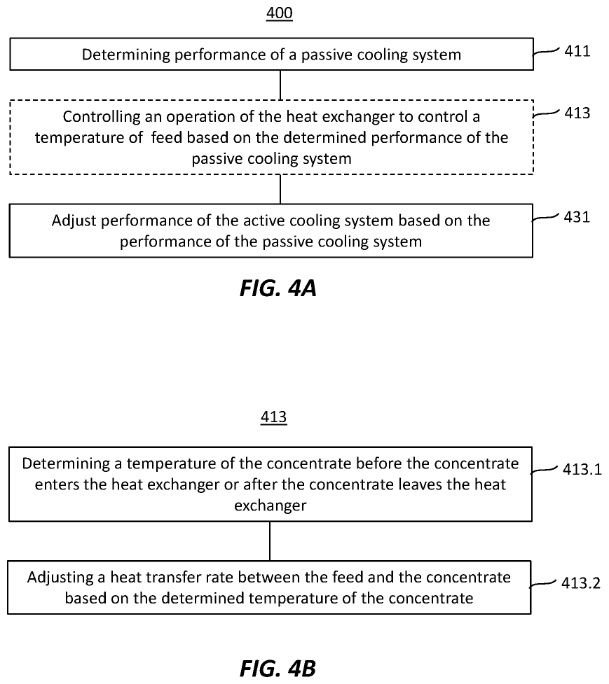

Further, the controller 333 can be configured to receive data from the sensors 355b and 355c associated with the heat exchangers 311a and 311b respectively and control various operational parameters of these heat exchangers, as further described below in relation to FIGS. 4-11. Additionally, the controller 333 can be configured to receive data from the sensor 355d associated with the membrane system 321 and control various operational parameters based on the received data, as further described below. The controller 333 may determine parameters associated with a concentrate flow 312 using the sensor 355e and a permeate flow 314 using the sensor 355f. For example, the controller 333 may determine flowrates of the concentrate and the permeate, or/and temperatures associated with the concentrate and the permeate.

FIG. 4A shows an example embodiment of a process 400 performed by a controller (e.g., the controller 333) for controlling a cooling system of a membrane system (e.g., the membrane system 121, 221, or 321). At step 411, the controller is configured to determine the performance of a passive cooling system associated with the membrane system. For example, the controller may determine if the passive cooling system is removing an adequate amount of heat from the membrane system. The heat removal from the membrane system by the passive cooling system may be based on various environmental factors (e.g., based on the temperature and/or airflow of ambient air) as well as the temperature of the membrane system. In some cases, the controller may be configured to determine the temperature of a membrane of the membrane system. If the temperature of the membrane is not within a target temperature range, the controller may determine that performance of a passive cooling system is not sufficient to cool the membrane system.

Alternatively, if the temperature of the membrane is within the target temperature range, the controller may determine that performance of the passive cooling system is sufficient. The target temperature range for the membrane may be selected specific to the particular membrane that is being used. For example, for graphene oxide membranes, the target temperature range may be between 60°−75° C., including all the temperature values in between. It should be understood that in some cases, graphene oxide membranes may also operate at lower temperatures (e.g., at a target temperature range of 30°−60° C.). Other types of membranes (e.g., polyamide membranes, membranes with cellulose or polyester, or membranes formed from materials that degrade at higher temperatures) may be configured to have a target temperature range that is typically lower than the target temperature range used for graphene oxide membranes. For example, these other types of membranes may operate within the target temperature range of 30°−60° C.

If the performance of the passive cooling system is not sufficient, the controller is configured to adjust the performance of an active cooling system associated with the membrane system. For example, if the passive cooling system removes only a fraction of the heat from the membrane system, the controller is configured to engage the active cooling system to remove the remaining amount of heat from the membrane system to maintain the membrane of the membrane system within a target range of temperature.

In some cases, the controller may gradually increase the heat transfer rate by the active cooling system while monitoring the temperature of the membrane. When the temperature of the membrane reaches a target value or range, the controller may be configured to stop increasing the heat transfer. The controller may use various approaches for increasing the heat transfer by the active cooling system, which may include, but not limited to, increasing a flow of cooling fluid past heat transfer surfaces of the membrane system, activating water sprayers configured for spraying heated surfaces (e.g., surfaces of a heatsink), activating fans, or engaging a cooling refrigeration system that may be associated with active cooling system, and the like.

As an optional step 413, the controller is configured to control the operation of a heat exchanger (e.g., the heat exchanger 111, 211a, 211b, 311a, or 311b) to control the temperature of the feed based on the determined performance of the passive cooling system of the membrane system, and/or based on a temperature of the membrane of the membrane system. In an example implementation, the controller may be configured to control the amount of heat removed from the feed by allowing a portion of the feed to bypass the heat exchanger. The bypassed “hot” feed can then be mixed with a “cool” portion of the feed, thus resulting in a target temperature of the feed. By supplying the feed at a target temperature (or at a temperature that is within a target temperature range, such as for example within a temperature range of 60-75° C., including all the temperature values and ranges in between), the membrane system may be maintained at a steady temperature and may not experience temperature fluctuations associated with the variations in feed temperature, outdoor weather conditions, and the like.

FIG. 4B shows sub-steps of step 413 of the process 400. For example, at sub-step 413.1, the controller is configured to determine the temperature of the concentrate before the concentrate enters the heat exchanger. In some implementations, at step 413.1, the controller is configured to determine the temperature of the concentrate after the concentrate leaves the heat exchanger. At sub-step 413.2, the controller is configured to adjust a heat transfer rate between the feed and the concentrate based on the determined temperature of the concentrate. For example, the controller may increase/reduce the heat transfer rate by increasing/reducing the heat transfer area between the feed and the concentrate. In an example implementation, such increase/reduction may be obtained via opening/closing valves configured to allow the feed to flow through an extended piping system.

In some cases, the feed may be delivered to the membrane system in a batch mode. For example, the feed may enter the heat exchanger and circulate withing the heat exchanger for a selected period of time (which may be controlled by the controller), thus transferring the heat to the concentrate during that time. After sufficient cooling is achieved, the feed can be directed from the heat exchanger to the membrane system or a second heat exchanger (e.g., the heat exchanger 211b or 311b) using the controller. For example, the controller may be configured to open/close suitable valves to direct the feed from the heat exchanger towards the membrane system or the second heat exchanger.

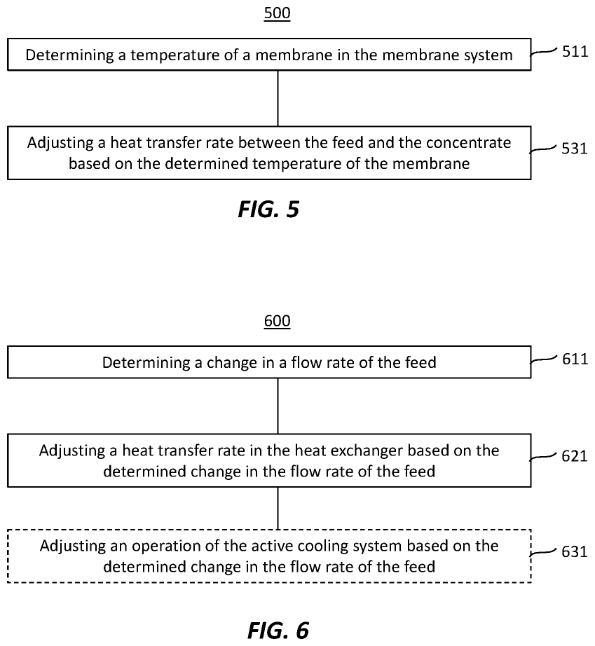

FIG. 5 shows an example process 500 performed by a controller (e.g., the controller 333) for controlling cooling system of a membrane system, which may be a simplified variation of the process 400. At step 511, the controller is configured to determine the temperature of a membrane in the membrane system, and at step 531, adjust a heat transfer rate between the feed and the concentrate based on the determined temperature of the membrane to reduce or increase the temperature of the membrane such that the temperature of the membrane is within a target temperature range. In some cases, the step of adjusting of the heat transfer rate can be performed iteratively, until the temperature of the membrane is within the target temperature range. For example, by adjusting the heat transfer rate, the controller is configured to increase a temperature of the feed if the membrane temperature is below a target temperature value and decrease the temperature of the feed if the membrane temperature is above the target temperature value.

FIG. 6 shows another example process 600 performed by a controller (e.g., the controller 333) for controlling temperature of a membrane system. At step 611, the controller is configured to determine if a change of feed flow is observed. In an example embodiment, the data regarding the feed flow rate may be reported by a sensor. At step 621, the controller is configured to adjust a heat transfer rate in a heat exchanger based on the determined change in the flow rate of the feed. For example, the heat transfer rate may be increased if the flow rate of the feed is increased or decreased if the flow rate is decreased. In some implementations, an increase in the heat transfer may be at least partially due to an increase in a flow rate of the concentrate (or permeate). Additionally, or alternatively, changes in heat transfer may be due to any other approaches (e.g., increase or decrease of heat transfer area, increase or decrease of convective cooling due to activation of fans, and the like). At step 631 (which may be an optional step), the controller is configured to adjust an operation of the active cooling system based on the determined change in the flow rate of the feed. For example, the active cooling system may be adjusted such that more or less heat is extracted from the membrane system.

In various implementations, the systems 100-300 may be configured to operate at feed flow rates that range between a few tens to a few hundred klb/hr. For example, the systems 100-300 may operate at a feed flow rate ranging between about 165 to about 220 klb/hr. Further, the heat exchanger may be configured to operate at flow rates for the concentrate in a range of a few tens to a few hundred klb/hr. In an example implementation, the heat exchanger is configured to operate at a concentrate flow rate in a range of about 110 to about 165 klb/hr.

In some cases, the heat exchanger is configured to heat the concentrate to a desired temperature. In an example implementation, operations of the heat exchanger may be configured to pursues two goals: (1) to cool the feed to a target feed temperature T_{f ref}, and (2) to heat the concentrate to a target concentrate temperature T_{c ref}. In some cases, both of these goals cannot be achieved simultaneously, and tradeoffs may be determined. For example, the controller may adjust a heat transfer rate between the feed and the concentrate based on the determined concentrate temperature (T_{c}) and feed temperature (T_{f}) to minimize a system objective function F. In an example implementation, the temperature T_{c} is measured as the concentrate leaves a membrane system (e.g., the membrane system 321, as shown in FIG. 3) and prior to entering a heat exchange (e.g., the heat exchanger 311a, as shown in FIG. 3). Further, the temperature T_{f} is measured before the heat enters the heat exchanger 311a. The objective function F can characterize such tradeoffs. For example, objective function F is at the absolute minimum if it is possible to achieve both T_{c ref}, and T_{f ref} simultaneously. Objective function F is, however, larger than the absolute minimum value if T_{c} is different from T_{c ref} or/and if T_{f} is different from T_{f ref}. An example objective function may be given by F=w₁(T_{c}−T_{c ref})²+w₂(T_{f}−T_{f ref})², wherein w₁ and w₂ are weights ranging between zero and one. In an example embodiment, if it is determined that it is much more important for T_{f} to be close to T_{f ref}, then w₂ is close to 1 and w₁ is close to 0 (e.g., w₂ is about 0.9 and w₁ is about 0.1). Alternatively, if it is determined that it is much more important for T_{c} to be close to T_{c ref}, then w₁ is close to 1, and w₂ is close to 0.

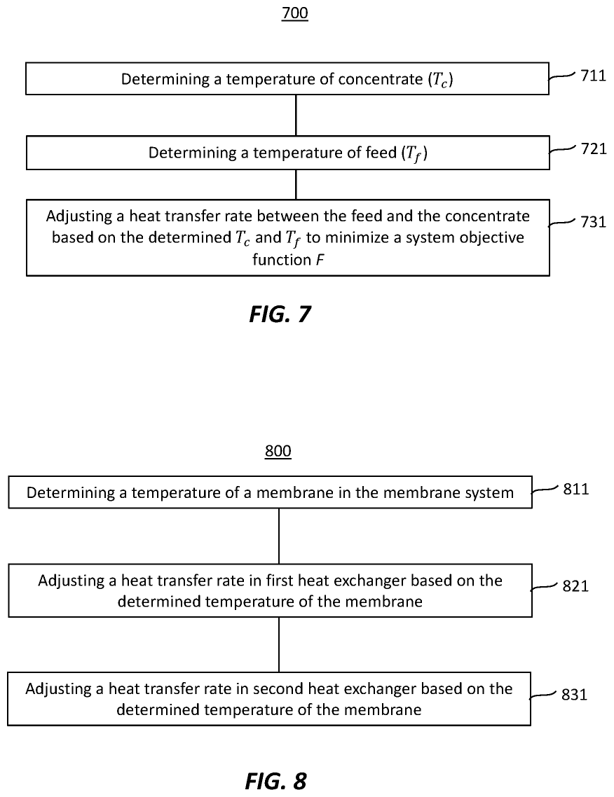

FIG. 7 shows an example process 700 that may be performed by a controller (e.g., the controller 333) to adjust a heat transfer rate between the feed and the concentrate. At step 711, the controller is configured to determine the temperature of the concentrate (71), and at step 721, the controller is configured to determine the temperature of the feed (T_{f}). In an example implementation, the controller determines T_{c} and T_{f} by obtaining data from temperature sensors. At step 731, the controller is configured to adjust the heat transfer rate between the feed and the concentrate based on the determined T_{c} and T_{f} to minimize the system objective function F as described above.

FIG. 8 shows an example process 800 that may be performed by a controller (e.g., the controller 333) to adjust a heat transfer in a first heat exchanger (e.g., the first heat exchanger 211a or 311a) and a second heat exchanger (e.g., the second heat exchanger 211b or 311b) based on a temperature of a membrane in the membrane system. At step 811, the controller is configured to determine a temperature of a membrane in the membrane system. Such determination may be made by the controller by receiving membrane temperature data from a temperature sensor associated with the membrane. At step 821, the controller is configured to adjust a heat transfer rate in the first heat exchanger based on the determined temperature of the membrane using any suitable approach discussed above (e.g., by increasing or decreasing a heat transfer area). At step 831, the controller is configured to adjust a heat transfer rate in the first heat exchanger based on the determined temperature of the membrane using any suitable approaches discussed above. In an example embodiment, the controller may be configured to increase a first heat transfer rate in the first heat exchanger by 20 percent and increase a second heat transfer rate in the second heat exchanger by 50 percent. It should be noted that any other suitable adjustment may be used. For example, if heating the concentrate is needed without significantly cooling the feed, the first heat transfer rate may be increased, while the second heat transfer rate may be decreased.

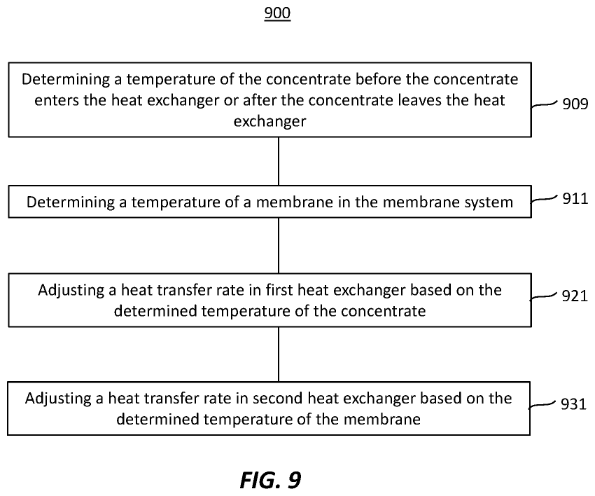

FIG. 9 shows an example process 900 that may be performed by a controller (e.g., the controller 333) to adjust a heat transfer in a first heat exchanger (e.g., the first heat exchanger 211a or 311a) and a second heat exchanger (e.g., the second heat exchanger 211b or 311b) based on a temperature of a membrane in the membrane system or temperature of the concentrate. At step 909, the controller is configured to determine the temperature of the concentrate before the concentrate enters the first heat exchanger or after the concentrate leaves the first heat exchanger. At step 911, the controller is configured to determine a temperature of a membrane in the membrane system. At step 921, the controller is configured to adjust a heat transfer rate in the first heat exchanger based on the determined temperature of the concentrate using any suitable approach discussed above (e.g., by increasing or decreasing a heat transfer area). At step 931, the controller is configured to adjust a heat transfer rate in the second heat exchanger based on the determined temperature of the membrane using any suitable approaches discussed above.

In some cases, the first heat exchanger is configured to heat the concentrate to a desired temperature T_{c ref} and to heat the permeate to a desired temperature T_{p ref}. In an example implementation, operations of the first heat exchanger may be configured to pursue three goals: (1) to cool the feed to a target feed temperature T_{f ref}, (2) to heat the concentrate to a target concentrate temperature T_{c ref}, and (3) to heat the permeate to a target permeate temperature T_{p ref}. In some cases, these three goals cannot be achieved simultaneously, and tradeoffs may be determined. For example, the controller may: adjust a heat transfer rate between the feed and the concentrate based on the determined concentrate temperature (T_{c}) and feed temperature (T_{f}), and adjust a heat transfer rate between the feed and the permeate based on the determined T_{c} and permeate temperature (Tₚ) to minimize a system objective function F. In an example implementation, the temperature Tₚ is measured as the permeate leaves a membrane system (e.g., the membrane system 321, as shown in FIG. 3) and prior to entering a heat exchange (e.g., the heat exchanger 311b, as shown in FIG. 3). The objective function can characterize such tradeoffs. For example, objective function F is at the absolute minimum if it is possible to achieve that T_{c ref} is T_{c}, T_{f ref} is T_{f}, and that T_{p ref} is Tₚ simultaneously. The objective function F is, however, larger than the absolute minimum value if T_{c} is different from T_{c ref}, and/or if T_{f} is different from T_{f ref}, or/and if Tₚ is different from T_{p ref}. An example objective function may be given by F=w₁(T_{c}−T_{c ref})²+w₂ (T_{f}−T_{f ref})²+w₃ (Tₚ−T_{p ref})², wherein w₁, w₂, and w₃ are weights ranging between zero and one. In an example embodiment, if it is much more important for T_{f} to be close to T_{f ref}, then w₂ is close to 1 and w₁ is closed to 0, w₃ is close to 0. For example, w₂ is about 0.9, w₁ is about 0.08, and w₃ is about 0.02. Alternatively, if it is much more important for T_{c} to be close to T_{c ref}, then w₁ is close to 1, w₂ is close to 0, and w₃ is close to 0. In some cases, w₃=0, and objective function is F=w₁ (T_{c}−T_{c ref})²+w₂(T_{f}−T_{f ref})². It should be appreciated that the expression for the cost function F as described above is only one possible expression, and other suitable expressions may be used. For example, cost function F may be calculated as F=w₁|T_{c}−T_{c ref}|+w₂|T_{f}−T_{f ref}|+w₃|Tₚ−T_{p ref}|, or using any other suitable expression (herein |T_{c}−T_{c ref}| is an absolute value of a difference T_{c}−T_{c ref}).

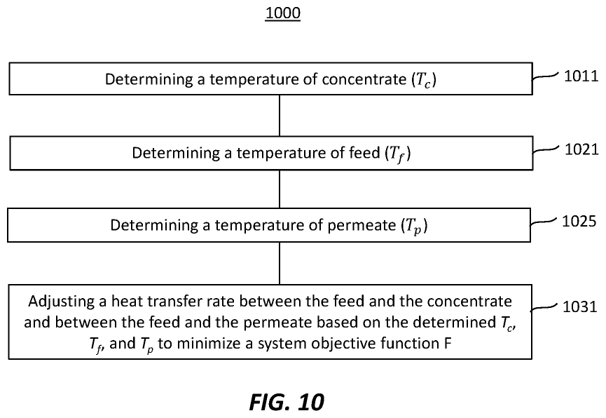

FIG. 10 shows an example process 1000 that may be performed by a controller (e.g., the controller 333) to adjust a heat transfer rate between the feed and the concentrate. At step 1011, the controller is configured to determine the temperature of the concentrate (T_{c}), at step 1021, the controller is configured to determine the temperature of the feed (T_{f}), and at step 1025, the controller is configured to determine the temperature of the permeate (Tₚ). In an example implementation, the controller determines T_{c}, T_{f}, and Tₚ by obtaining data from temperature sensors. At step 1031, the controller is configured to adjust the heat transfer rate between the feed and the concentrate, and between the feed and the permeate, based on the determined T_{c}, T_{f}, and Tₚ to minimize the system objective function F as described above.

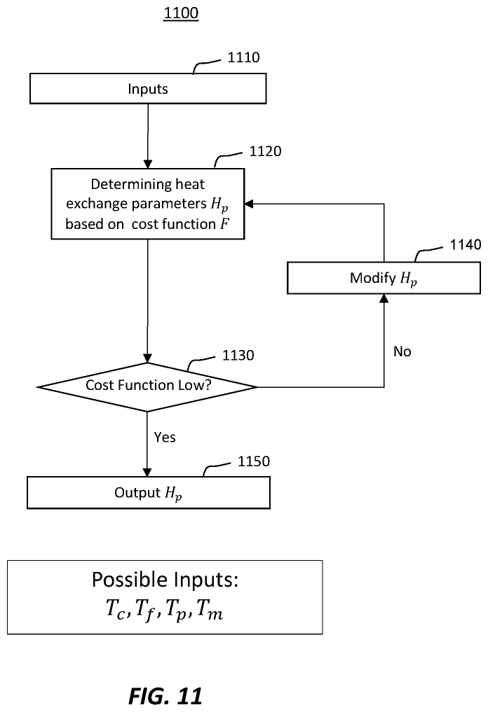

FIG. 11 illustrates an example process 1100 of determining heat exchange parameters H p based on cost function F. In an example embodiment, heat exchange parameters are parameters that control heat transfer rates for first and second heat exchangers. For example, such parameters may be heat transfer areas for first and second heat exchangers, the power delivered to fans of the first heat exchanger and/or second heat exchanger, or any other parameters associated with the heat exchangers that control heat transfer rates for these heat exchangers. At step 1110, inputs (e.g., T_{c}, T_{f}, and Tₚ) are used to determine cost function F. In some cases, temperature of the membrane of the membrane system may also be used as an input. In an example embodiment, cost function F may be calculated as F=w₁ (T_{c}−T_{c ref})²+w₂(T_{f}−T_{f ref})²+w₃(Tₚ−T_{p ref})²+w₄(Tₘ−T_{m ref})², where T in is a temperature of a membrane determined by an associated sensor, and T m re f is a reference temperature for the membrane. Further, w₄ is a weight associated with the term (Tₘ−T_{m ref})².

At step 1130, the controller evaluates whether the cost function computed for inputs provided at step 1110 is sufficiently low. For example, the controller may check that the cost function is lower than a predetermined threshold, and if that is the case (step 1130, Yes), the controller is configured to output heat exchange parameters H p at step 1150. Alternatively, if the generated cost function is not sufficiently low (step 1130, No), the controller is configured to further modify heat exchange parameters H p at step 1140, and proceed to step 1120, at which a new cost function is determined.

Examples of temperature, flow rate, pressure, recovery rate, and heat loading parameters

In some implementations of the systems 100-300, the feed is a liquid (e.g., a dark liquor that is used in Kraft process when making a paper). In an example implementation, temperatures for the feed may be 100 degrees Celsius (100° C.) or less. In some implementations, the feed temperatures are 80° C. to 95° C. In an example implementation, a concentrate from a filtration process (when using a membrane system, such as membrane system 321, as shown in FIG. 3) may have the temperature T_{c} that is a few degrees lower than the feed temperature T_{f} (e.g., T_{c} may be about 5° C. lower than T_{f}). A permeate can be produced at a temperature that may be controlled (e.g., by cooling membrane system 321). In an example implementation the permeate temperature Tₚ may be in a range of 70-80° C. However, other values for Tₚ may be used, depending on the process requirements. In some cases, Tₚ may range between 50° C. to 65° C. In various implementations, Tₚ is likely to be larger than 40° C.

In some implementations of the systems 100-300, the flow rate of the feed to the heat exchanger (e.g., the feed flow 310) may range between 165 to 220 klb/hr. In some cases, when the feed is the black liquor, 300 to 400 GPM gallons per minute (GPM) may be used as the feed flow rate. The flow rate of the concentrate delivered by the membrane system may vary depending on the membrane system recovery. In some cases, the flow rate for the concentrate may be in the range of 110 to 165 klb/hr, which is equivalent to 200 to 300 GPM. The flow rate of the permeate can be determined as a difference in mass flow of the feed and the concentrate and is thus about 100 GPM. In some implementations, the flow rate of the permeate for a weak black liquor (WBL) concentration is at least about 10%, at least about 15%, at least about 20%, or at least about 25% of the feed flow rate. In some implementations, the flow rate of the permeate for a WBL concentration is no more than about 40%, no more than about 45%, no more than about 50%, no more than about 55%, or no more than about 60% of the feed flow rate. Combinations of the above-referenced ranges for the ratio of the permeate flow rate over the feed flow rate are also contemplated. For example, the flow rate of the permeate may be between 10%-30% or between 30%-60% of the feed flow rate, including all values or ranges in between. In various implementations, the systems 100-300 may be scaled to have feed flow rates that are about 5 to 20 times than the flow rate of 300 GPM. For example, larger systems may have the feed flow rate of 6000 GPM.

In various implementations, heat exchangers used by the systems 100-300 may operate near atmospheric pressure (100 psi or less). In some implementations, the systems 100-300 may not utilize compressors, refrigeration, etc. due to the elevated temperature and liquid phase. In some implementations, pressures for the heat exchangers may not be substantially below atmospheric pressure. For example, in some implementations, the pressures may be less than atmospheric pressure by at most 5% to 10%.

In various implementations of a membrane system (e.g., membrane system 321, as shown in FIG. 3), the mass flow of the concentrate (and/or the permeate) is lower than feed mass flow (e.g., the mass flow of the concentrate may be 40% to 80% of the feed mass flow). Thus, the temperature change between the inlet temperature (e.g., the temperature of the concentrate prior to entering the heat exchanger) and the outlet temperature (e.g., the temperature of the concentrate after exiting the heat exchange) is larger than the temperature change of the feed. This has the benefit of allowing the concentrate to be heated to nearly the same temperature as the temperature of the feed (T_{f}). The permeate can also be used to dissipate heat from the feed. It should be noted that various processes involving the feed and the concentrate typically occur at higher temperatures than those for the permeate, thus, the permeate is expected to be at a lower temperature than the feed and the concentrate.

Considering the feed flow rates of 300 to 400 GPM, as well as temperatures and flow rates discussed above, the feed/concentrate heat exchange may require a 6.5-7.0 MBTU/hr heat exchange operation. This translates to about 950-1000 ft² of effective heat transfer area assuming an overall heat transfer coefficient of 432 BTU/hr·ft²·F. In some implementations, the concentrate temperature may be about 50-60° C. to cool the feed to about 70° C. Conservatively, assuming an overall heat transfer coefficient for the system at 2.6 BTU/hr·ft²·F, this would mean that about 25,000 ft² of the heat transfer area is may be used with the ambient air temperature at 25° C. In some cases, various enclosures (vessels) of the systems 100-300 may contribute about 8000 ft² of this heat transfer area with the remaining heat dissipation being provided by the heat transfer area of piping of the systems 100-300. In cases when convective heat transfer process dominates the heat transfer, a smaller heat transfer area may be used.

As discussed above and further recapped here, passive and active cooling strategies may be used. For example, heat exchangers of the systems 100-300 may dissipate heat to the surroundings passively just by having uninsulated piping and membrane housings. However, it may also have more active cooling such as the spraying of water on tanks or membrane housings, cooling fins for greater passive cooling, or active air-cooling systems, or additional heat exchangers in contact with cooling water or other process fluids. The use of a flow control bypass loop around a heat exchanger (e.g., the heat exchanger 311a) can improve the setpoint control for feed temperature to a membrane system (e.g., the membrane system 321). For example, in cooler months or particularly windy days, passive cooling on the system will naturally be greater and thus lead to potentially greater than desired heat removal from the feed stream. Use of a flow-controlled bypass loop will allow a control system (e.g., the controller 333) to bypass as much feed as necessary around the exchanger to control to a desired system inlet temperature.

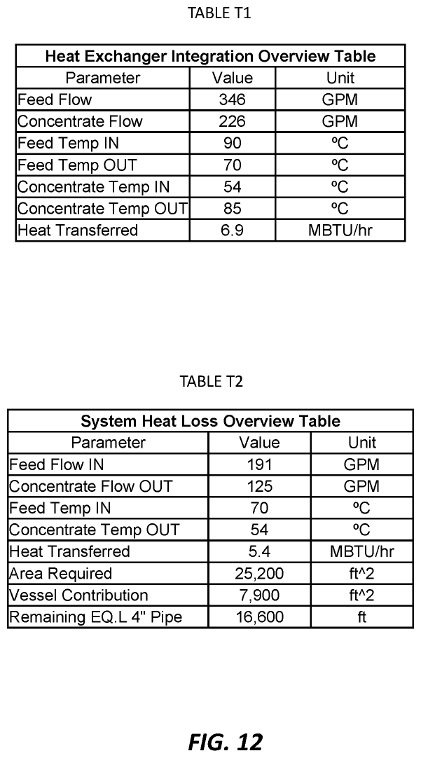

Example parameters for operating the systems 100-300 are further summarized in tables T1 and T2 as shown in FIG. 12. For example, table T1 shows possible parameters related to a heat exchanger (e.g., the heat exchanger 311a, as shown in FIG. 3). For example, table T1 shows the feed flow rate (into the heat exchanger 311a), the concentrate flow rate (from a membrane system, such as the membrane system 321, as shown in FIG. 3), the feed temperature in (e.g., the feed temperature before the feed enters the heat exchanger 311a), the feed temperature out (e.g., the feed temperature after the feed exits the heat exchanger 311a), the concentrate temperature in (e.g., the concentrate temperature before the concentrate enters the heat exchanger 311a), the concentrate temperature out (e.g., the concentrate temperature after the concentrate exits the heat exchanger 311a), and the total of heat transferred between the feed and the concentrate in the heat exchanger 311a. Table T2 shows possible parameters related to a heat loss in the membrane system 321, such as the feed flow rate in (e.g., the feed flow rate into the membrane system 321), the concentrate flow out (e.g., the concentrate flow out of the membrane system 321), the feed temperature in (e.g., the feed temperature before the feed enters the membrane system 321), the concentrate temperature out (e.g., the concentrate temperature after the concentrate exits the membrane system 321), the total of heat transferred between the feed and the concentrate in the membrane system 321, the total heat transfer area associated with the membrane system 321, the heat transfer area associated with an enclosure (vessel) for the membrane system 321, and the heat transfer area associated with piping of the membrane system 321.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of the present technology may be implemented using hardware, firmware, software, or a combination thereof. When implemented in firmware and/or software, the firmware and/or software code can be executed on any suitable processor or collection of logic components, whether provided in a single device or distributed among multiple devices.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The terms “substantially,” “approximately,” and “about” used throughout this Specification and the claims generally mean plus or minus 10% of the value stated, e.g., about 100 would include 90 to 110.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system, comprising:
a membrane system configured to receive a liquid feed and produce a concentrate and a permeate, the membrane system including:
a graphene oxide membrane;
a passive cooling system; and
an active cooling system;
a heat exchanger in fluid communication with the membrane system and disposed upstream of the membrane system such that the liquid feed enters the membrane system immediately after exiting the heat exchanger, the heat exchanger configured to cool the liquid feed; and
a controller configured to:
determine performance of the passive cooling system; and
adjust an operation of the active cooling system based on the determined performance of the passive cooling system, such that cooling of the membrane system is at a target cooling level.

2. The system of claim 1, wherein the liquid feed comprises black liquor.

3. The system of claim 1, wherein the active cooling system includes at least one of a water sprayer, a heat sink with cooling fins, or a membrane system heat exchanger.

4. The system of claim 1, wherein the passive cooling system includes an insulated piping, a membrane housing, or a combination thereof.

5. The system of claim 1, wherein the controller is further configured to control an operation of the heat exchanger to control a temperature of the liquid feed based on the determined performance of the passive cooling.

6. The system of claim 1, wherein the heat exchanger is further configured to heat the concentrate by transferring heat from the liquid feed to the concentrate, and the controller is further configured to:
determine a temperature of the concentrate before the concentrate enters the heat exchanger or after the concentrate leaves the heat exchanger; and
adjust a heat transfer rate between the liquid feed and the concentrate based on the determined temperature of the concentrate.

7. The system of claim 6, wherein adjusting the heat transfer rate includes reducing or increasing an effective heat transfer area of the heat exchanger.

8. The system of claim 6, wherein adjusting the heat transfer rate includes:
separating a flow of the liquid feed into a first flow and a second flow, wherein:
the first flow is configured to pass through the heat exchanger;
the second flow is configured to bypass the heat exchanger; and
the controller is configured to determine a magnitude of the first flow and/or second flow; and
recombining the first and the second flow after the first flow passes through the heat exchanger.

9. The system of claim 6, wherein the controller is further configured to determine a membrane temperature and adjust a heat transfer rate between the liquid feed and the concentrate based on the determined membrane temperature.

10. The system of claim 9, wherein the controller is configured to:
increase a temperature of the liquid feed if the membrane temperature is below a target temperature value; and
decrease the temperature of the liquid feed if the membrane temperature is above the target temperature value.

11. A system, comprising:
a membrane system configured to receive a liquid feed and produce a concentrate and a permeate, the membrane system including:
a graphene oxide membrane;
a first heat exchanger in fluid communication with the membrane system and disposed
upstream of the membrane system;
a second heat exchanger in fluid communication with both the first heat exchanger and the membrane system and disposed between the first heat exchanger and the membrane system, such that the liquid feed enters the first heat exchanger, the second heat exchanger, and the membrane system sequentially; and
a controller configured to:
determine the membrane temperature;
adjust a heat transfer rate in the first heat exchanger based on the determined membrane temperature; and
adjust a heat transfer rate in the second heat exchanger based on the determined membrane temperature;
wherein the first heat exchanger is configured to cool the liquid feed and heat the concentrate by transferring heat from the liquid feed to the concentrate.

12. The system of claim 11, wherein the liquid feed includes black liquor.

13. The system of claim 11, wherein the controller is further configured to:
determine a temperature of the concentrate before the concentrate enters the first heat exchanger or after the concentrate leaves the first heat exchanger; and
adjust the heat transfer rate in the first heat exchanger based on at least one of the determined temperature of the concentrate, or the membrane temperature.

14. The system of claim 11, wherein the controller is further configured to:
determine a change in a flow rate of the liquid feed; and
adjust the heat transfer rate in the first heat exchanger or the second heat exchanger based on at least one of the determined change in the flow rate of the liquid feed or the membrane temperature.

15. The system of claim 11, wherein the second heat exchanger is configured to cool the liquid feed and heat the permeate by transferring heat from the liquid feed to the permeate; and the controller is further configured to:
determine a temperature (T_{c}) of the concentrate;
determine a temperature (T_{f}) of the liquid feed;
determine a temperature (Tₚ) of the permeate; and
adjust a heat flow between the liquid feed and the concentrate and between the liquid feed and the permeate based on the determined T_{c}, T_{f}, and Tₚ to minimize a system objective function F.

16. The system of claim 15, wherein the system objective function F is F=w₁(T_{c}−T_{c ref})²+w₂(T_{f}−T_{f ref})², wherein T_{c ref} is a concentrate reference temperature, and T_{f ref} is a feed reference temperature, and w₁ and w₂ are weights ranging between zero and one.

17. The system of claim 15, wherein the system objective function F is F=(T_{c}−T_{c ref})²+w₂(T_{f}−T_{f ref})²+w₃(Tₚ−T_{p ref}), wherein T_{c ref} is a concentrate reference temperature, T_{f ref} is a feed reference temperature, and T_{p ref} is a permeate reference temperature, and w₁, w₂, and w₃ are weights ranging between zero and one.

18. A system, comprising:
a membrane system configured to receive a liquid feed and produce a concentrate and a permeate, the membrane system including:
a graphene oxide membrane;
a heat exchanger in fluid communication with the membrane system and disposed upstream of the membrane system such that the liquid feed enters the membrane system immediately after exiting the heat exchanger, the heat exchanger configured to cool the liquid feed and heat the concentrate by transferring heat from the liquid feed to the concentrate; and
a controller configured to determine the membrane temperature and adjust a heat transfer rate between the liquid feed and the concentrate based on the determined membrane temperature.

19. The system of claim 18, wherein the liquid feed includes black liquor.

20. The system of claim 18, wherein the heat exchanger operates at about atmospheric pressure.

21. The system of claim 18, wherein the membrane system further comprises:
a passive cooling system; and
an active cooling system including at least one of a water sprayer, a heat sink with cooling fins, or a membrane system heat exchanger.

22. The system of claim 21, wherein the controller is further configured to:
determine performance of the passive cooling system; and
adjust an operation of the active cooling system based on the determined performance of the passive cooling system, such that cooling of the membrane system is at a target level.

23. The system of claim 18, wherein the controller is further configured to:
increase a temperature of the liquid feed if the membrane temperature is below a target temperature value; and
decrease the temperature of the liquid feed if the membrane temperature is above the target temperature value.

24. The system of claim 18, wherein a temperature difference between the concentrate prior to entering the heat exchanger and the liquid feed prior to entering the heat exchanger is between about 10-40 degrees Celsius.

25. A system, comprising:
a membrane system configured to receive a liquid feed and produce a concentrate and a permeate, the membrane system including:
a graphene oxide membrane;
a first heat exchanger in fluid communication with the membrane system and disposed
upstream of the membrane system;
a second heat exchanger in fluid communication with both the first heat exchanger and the membrane system and disposed between the first heat exchanger and the membrane system, such that the liquid feed enters the first heat exchanger, the second heat exchanger, and the membrane system sequentially; and
a controller configured to:
determine a change in a flow rate of the liquid feed; and
adjust a heat transfer rate in the first heat exchanger or the second heat exchanger based on the determined change in the flow rate of the liquid feed;
wherein:
the first heat exchanger is configured to cool the liquid feed and heat the concentrate by transferring heat from the liquid feed to the concentrate; and
the second heat exchanger is configured to cool the liquid feed and heat the permeate by transferring heat from the liquid feed to the permeate.

26. The system of claim 25, wherein the liquid feed includes black liquor.

27. The system of claim 25, wherein adjusting the heat transfer rate in the first heat exchanger or the second heat exchanger includes reducing or increasing an effective heat transfer area of the first heat exchanger or the second heat exchanger.

28. The system of claim 25, wherein the controller is further configured to:
determine a temperature of the concentrate before the concentrate enters the first heat exchanger or after the concentrate leaves the first heat exchanger; and
adjust a heat transfer rate in the first heat exchanger between the liquid feed and the concentrate based on the determined temperature of the concentrate.

29. The system of claim 25, wherein the controller is further configured to:
determine a temperature (T_{c}) of the concentrate;
determine a temperature (T_{f}) of the liquid feed;
determine a temperature (Tₚ) of the permeate; and
adjust a heat flow between the liquid feed and the concentrate and between the liquid feed and the permeate based on the determined T_{c}, T_{f}, and Tₚ to minimize a system objective function F.

30. The system of claim 29, wherein the system objective function F is F=w₁(T_{c}−T_{c ref})²+w₂(T_{f}−T_{f ref})²+w₃(Tₚ−T_{p ref}), wherein T_{c ref} is a concentrate reference temperature, T_{f ref} is a feed reference temperature, and T_{p ref} is a permeate reference temperature, and w₁, w₂, and w₃ are weights ranging between zero and one.
